(19) United States
(12) Patent Application Publication
(10) Pub. No.: US 2007/0055434 A1
(43) Pub. Date: Mar. 8, 2007

(54) Automatic control system for controllin a vehicle on demand

(76) Inventor: Henry George Kohlmann, Huntington Beach, CA (US)

Correspondence Address: Henry G Kohlmann, 15460 Laguna Canyon Road, MC 1650-7003, Irvine, CA, 92618, US

(21) Appl. No.: 10/527,537

(22) PCT Filed: Sep. 12, 2003
(86) PCT No.: PCT/US03/28699

§ 371 Date: Mar. 11, 2005

Related U.S. Application Data
(60) Provisional application No. 60/410,664, filed on Sep. 12, 2002.

(51) Int. Cl. G06F 19/00; G06G 7/70

(52) U.S. Cl. 701/100

(57) ABSTRACT

In an aircraft or other mobile transport, a communication system, exists to control the flight of the aircraft in the event of a hijacking or other emergency. The system is based on a central computer system, such as the autopilot system interfaces with either a broad band or narrow band communication system or both for communication between a ground station and the aircraft. Some systems permit both broad band and communication between ground based facilities and passenger and crew on the aircraft. A system is herein described which can is used to gather visual or audio data to aid in thwarting hijackers or determining other emergency on board the mobile transport. On detection of an emergency event, the control of the mobile transport is taken over from the on board operators and managed from a stationary monitoring site.

### RELATED APPLICATIONS

This application is related to Provisional Application entitled Automatic Control System for Controlling a Vehicle on Demand Ser. No. 60/410,664, filed Sep. 12, 2002 and incorporated herein by reference. Applicant claims priority of such application and all other rights thereto to the extent applicable.

### BACKGROUND OF THE INVENTION

1. Field of the Invention

The field of this invention relates generally to mobile communications and emergency control. More specifically the field of this invention is related to the interface of a communications system with computers on board a movable platform which are coupled to video or audio monitors within the passenger cabin and operator cabin aboard the mobile platform which permits others on the ground or on other mobile platforms to access the movable platform.

2. Related Art

Various options are present in the art for protection against the hijacking or commandeering of aircraft. These options are focused primarily on barriers and detectors on the specific vehicle or mobile platform. These are typified in U.S. Pat. No. 6,584,383, the “Pippenger,” patent filed Sep. 28, 2001 after applicant's invention of the invention described in this application and issued Jun. 24, 2003. U.S. Pat. No. 6,584,383 is incorporated herein by reference. While Pippenger describes a method of taking control of an aircraft by operation of a switch by the pilot to send a code and then results in takeover and landing of the aircraft, there is no monitoring capability to determine if an emergency actually exists. There is an intrusion detection device which is located at the cabin door which when triggered sends a signal to the on board system. Further the aircraft is directed to the nearest acceptable airport which permits it to fly over inhabited areas. There is a proximity detection system on board that will avoid terrain obstacles. There remains the likelihood that some terrorist will eventually find a way to get weapons or a bomb on the aircraft and gain access into the control cabin to take over control of the aircraft by simply disabling the security navigation module. Therefore no matter how secure an individual vehicle may be is there may still be instances of hijacking and the occurrence of another disaster such as occurred in New York, and other locations on the East Coast of the U.S. Pippenger is vulnerable to disengagement and does not guard against destruction of an aircraft over heavily inhabited areas.

Numerous prior systems exist for the automatic control and landing of aircraft in various adverse weather conditions such as that disclosed in U.S. Pat. No. 4,493,114, issued to Ruhl on Jan. 14, 1997. That system was based in part on the Instrument Landing Systems, ILS systems in use today, which evolved from the early use of radio frequency beams installed at the airport to provide beams guidance for aircraft to a runway. The beam consists of radio frequencies, which emanate from ground-based antennas with the radiated fields overlapping so that with equal strength of each of the radiated fields an approximate straight line is established. A localizer and glide slope set of antennas (on-board the aircraft) are required.

The FAA has developed a new system over the last 20 years called Microwave Landing System (MLS) to replace the ILS. The MLS system is intended to also provide ground based signals for category I<II<and III landing systems for use during inclement weather.

Other systems have also been introduced. Such as the Global Positioning System (GPS) where the Civilian service is the Standard Positioning Service (SPS) and a more accurate Precise Positioning Service (PPS) is used for U.S. Military. Numerous other positioning systems exist around the world and can be used for altitude, and global position determination. The threat of hijacking and commandeering of aircraft, ships and other vehicles is of great concern to those in the United States since the Sep. 11, 2001 hijacking of aircraft and destruction of the World Trade Center, in New York City. It is therefore of interest to provide a system, which would minimize the destructive nature of hijacked vehicles, used as weapons.

Various options for protection against hijacking are focused on barriers and detectors. Many of these various options are focused on aircraft although any vehicle may be the subject of hijacking. Notwithstanding barriers and detectors, there is the likelihood that some terrorist will find a way to get weapons on the aircraft and get into the cockpit. In addition to isolating the cockpit, there could be a built in second metal detector in the airplane door, which would activate an alarm in the event a passenger carrying a weapon enters the plane as well. These various options are focused on the airplane. The reality is that some terrorist will find a way to get weapons on the aircraft and get into the cockpit. So barriers and detectors may simply not work. We still have another disaster.

There is a need therefore to use a system which not only avoids collision with terrain, other air vehicles, and goes to the nearest acceptable airport by flying over minimally inhabited areas. In addition it is important to the authorities to be able to determine if there is a true emergency on board by being able to monitor the cabin and cockpit areas.

### SUMMARY OF THE INVENTION

The present invention describes a wireless communication system, to monitor the operation of the mobile platform, in this case an aircraft is used to exemplify the specific embodiment, although it should be clearly understood that this invention is equally applicable to any mobile vehicle whether it carries passengers or not. The monitoring of the aircraft can be conducted in the event of a hijacking or other emergency. The system is based on a central computer system, such as the autopilot system, any similar system or a newly added piloting system to the aircraft to operate the invention and interfaces with either a broad band or narrow band communication system or both for communication between a ground station, another aircraft and the monitored aircraft. Some systems permit both broad band and narrow band communication between ground based facilities and passenger and crew on the aircraft. A system is herein described which can is used to gather data to aid in thwarting hijackers or determining other emergency, automatic take over control of the aircraft under certain circumstances or permit flight control from the ground or other aircraft and land it at an appropriate airport by carefully avoiding highly inhabited areas. In the case of other vehicles control may be to simply stop the vehicle or send it to a siding or secured area. While the use of this system is described as on an aircraft, it could be on any mobile transportation vehicle, including cars, boat, trains, satellites and the like. Other emergencies could be a control system defect or the illness of train engineers, pilots, and the like. The preferred embodiment of the system includes video security cameras and security microphones in the cockpit and in the cabin at such locations, which permit a visual and audio view of the entire aircraft or at least significant portions thereof. The video images can be sent via the broadband wireless communication system to a ground based monitoring station for recording and viewing. Audio can be sent over narrow band wireless radio. A broad band communication system is described in U.S. patent application Ser. No. 09/639,912, filed Aug. 16, 2000; Ser. No. 09/989,742, filed Nov. 20, 2001 and PCT/US01/22157, filed Jul. 13, 2001, each entitled “Method and Apparatus for Providing Television and Data Services to Mobile Platforms” which are each incorporated herein by reference. While some special systems described herein exist any electronic communication system may be used to provide rudimentary security service and a control systems interface. One of these is described in Patent application Ser. No. 9/912,355 entitled Global Communications, Navigation and Surveillance system (GCNS) and filed on Oct. 5, 2001, which is incorporated herein by reference.

Further application Ser. No. 09/994,259 filed Nov. 26, 2001 describes a system for ground control of an aircraft by he use of real time streaming data to and from the aircraft to relieve the burden of the aircraft carrying on-board, stored data and permit flight control of the aircraft where appropriate. This application is also incorporated herein by reference. The present terrain awareness system draws upon simplified terrain models, which are currently embedded within the aircraft ground proximity warning system. The systems described in these applications permits passengers to access ground stations and send and receive broadband data such as movies or permit Internet surfing.

The current invention system may be used to automatically photograph personnel when loading the aircraft or it could send a distress signal when activated to alert ground personnel to monitor cockpit and cabin activities in real time. Since there would be little interest in the case of a hijack situation in surfing the Internet or other activities, the full bandwidth could be dedicated to the single system. This would provide authorities with critical decision information.

The present invention provides a way of taking control of the vehicle away from the occupants and safely positioning it at some safe location for law enforcement or emergency personnel. In addition, the present invention provides a means of surveillance of the interior of the vehicle so that authorities at control locations can view any aircraft or other vehicle while in route to determine if any action must be taken.

The security cameras and microphones may be in continuous operation, turned on only at randomly selected times or in the event of a distress signal, indicating an emergency event, which can be operated from the cockpit, the cabin or other locations to alert ground personnel to the need to monitor cockpit and cabin activities in real time on a particular aircraft for an emergency event.

This would provide authorities with critical real time decision information to determine what and where to evacuate, tactical decision information to respond to the emergency event and general information as to what is taking place on the aircraft. Such a system could include retrieving and recording technical aircraft status information as well, all in real time.

### BRIEF DESCRIPTION OF THE DRAWINGS

FIG. 1 shows various runway locations and obstacles such as a city and mountains.

FIG. 2 shows various runway locations and obstacles with zone perimeters around them

FIG. 3 shows various routes computed for obstacles avoidance and path runway

FIG. 4 shows Airport location and related information.

FIG. 5 shows ILS entry location and related information.

FIG. 6 shows obstacles location and related information

FIG. 7 is a block diagram of the aircraft control system and optional chase aircraft.

FIG. 8 is a block diagram of the aircraft control system with embedded control code

FIG. 9 is a block diagram of the controls apparatus coupled to control surfaces and engine

FIG. 10 is a block diagram of the Aircraft data sources

FIG. 11 shows the Emergency route information including waypoint information.

FIG. 12 shows the Emergency route information and an aircraft in an emergency situation

FIG. 13 shows the Aircraft heading for an emergency route to land at airport a1

FIG. 14A through 14F show the method steps for the system

### PREFERRED EMBODIMENT

The onboard system communication system is coupled to video cameras in the cockpit or in the cabin at selected locations. These cameras permit a view of the entire aircraft. The video images generated by the camera can be sent via the wireless communication system to a ground based recording and viewing location.

While GPS location system is described, any other location system, which may be developed in the future, may be used. Many other landing systems may be similarly used as herein described in addition to ILS.

Most commercial aircraft today are fly-by-wire systems, which permit flight control of the aircraft through electrical signals between the control yoke and other cockpit systems and the various engines, and control surfaces. Thus, fly by wire systems do not have direct mechanical control from the cockpit to the control surfaces and other aircraft systems. The present invention interfaces with the aircraft fly by wire system to permit alternate control of the aircraft at any point in flight. That is, once a pilot or anyone else indicates a distress situation in flight by a switch or other device or when an emergency is determined by ground control, or automatically such as deviation from course which cannot be explained by the pilot, the communication system could be used to send control information to the fly by wire system and control the flight of the aircraft where necessary, such as in a hijacking situation, the cabin controls and other controls accessible by those on board could be isolated, thereby eliminating hijacking aircraft control access and thus success. It is unlikely that any system can prevent the loss of the aircraft commandeered by terrorists who are willing to die, but at least the disaster would be limited to that airplane and hopefully occur over uninhabited areas. This way our governmental authorities could ensure that no aircraft can be commandeered for long. It would also mean that government officials would not need to make the terrible decision to shoot down a commercial aircraft, which has been taken by terrorists to prevent death and injury to thousands of people on the ground.

The interface to the fly by wire system interfaces between the wireless control information received, the autopilot and the automatic landing systems. Current autopilot systems, which steer the aircraft course and interface with on board automatic landing systems, which land that aircraft are well known. In some cases these systems may need to be duplicated in hardware or software systems in the wings and other location, which are inaccessible in flight. Aircraft position and other information would similarly be transmitted to ground control through the wireless communication system. An interface to these systems is within the skill of the art. Both must be reprogrammed to allow depriving the pilot of the ability to disconnect the automatic systems. In addition, the entire communication system, auto pilot and automatic landing system may need to be located remotely so that no onboard effort can retake control without intervention from the ground.

In the event of a hijacking or other emergency event, the pilot, some other person on the aircraft or a monitoring ground station initiates an alert event. The cockpit is isolated and the ground station takes over. The autopilot would be set for a landing destination, and routed over minimally habited areas. The route to the destination is initially calculated to avoid cities and natural obstacles based in a set of waypoint tables in the control computer, which can be automatically reprogrammed as necessary during the flight to avoid collision with other aircraft and then return to the programmed route. When a destination is reached the automatic landing system is activated at the landing approach point and takes over landing of the aircraft.

There is a possibility of someone breaking into the ground control system at the time the pilot turns over the aircraft to ground control. This would permit the terrorists to still control the aircraft if they are able to enter the control system without boarding the aircraft.

Therefore, a default, aircraft return system, which would return the aircraft to an airport is considered part of this system. The system would download location information when at the airline terminal by either wire or wireless information transfer or use a GPS location reference for comparison against an airport database, which includes at least location and runway information. A cockpit control and a ground control could be used to activate a computer routine to compute the aircraft location at the time the control is set and then determine the route to the nearest airport in the data base capable of accepting the aircraft.

Emergency transponders (isolated from the cockpit or engineering) aboard the aircraft are activated to indicate to ground control that the aircraft has an emergency in which the pilot is unable to control the operation of the aircraft.

The aircraft return system would refuse all wireless control information from any wireless system including the above described wireless system and would simply lock on to the nearest airport capable of handling the aircraft. Once activated the cockpit will remain isolated so that the aircraft cannot be rerouted or the control reset nor can the aircraft be forced into the ground or any structures. It will land at the nearest airport capable of receiving the aircraft.

The wireless audio and video surveillance system will remain active, as it does not include control information and activity aboard the aircraft can be continually monitored.

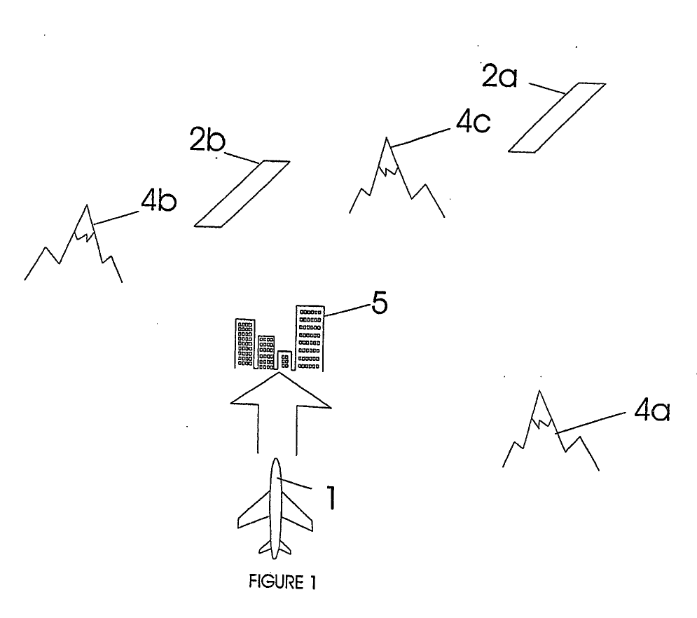

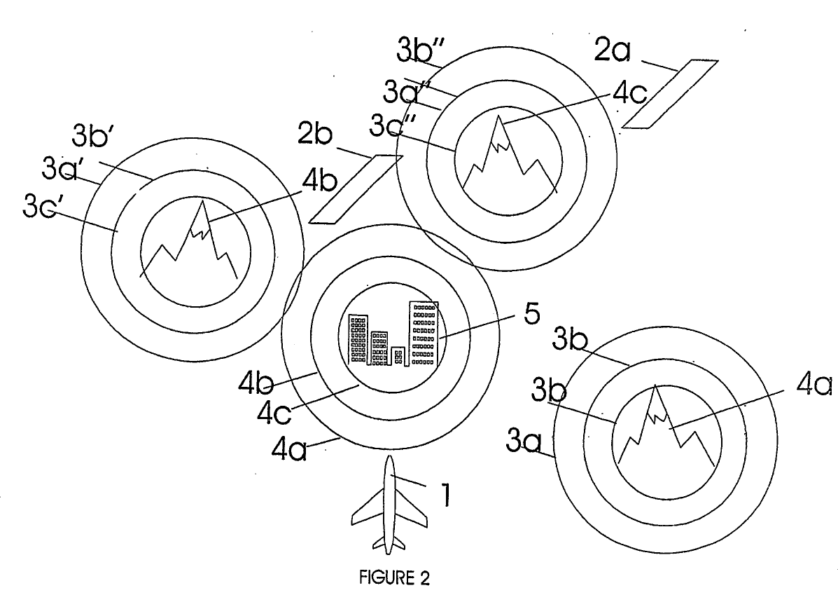

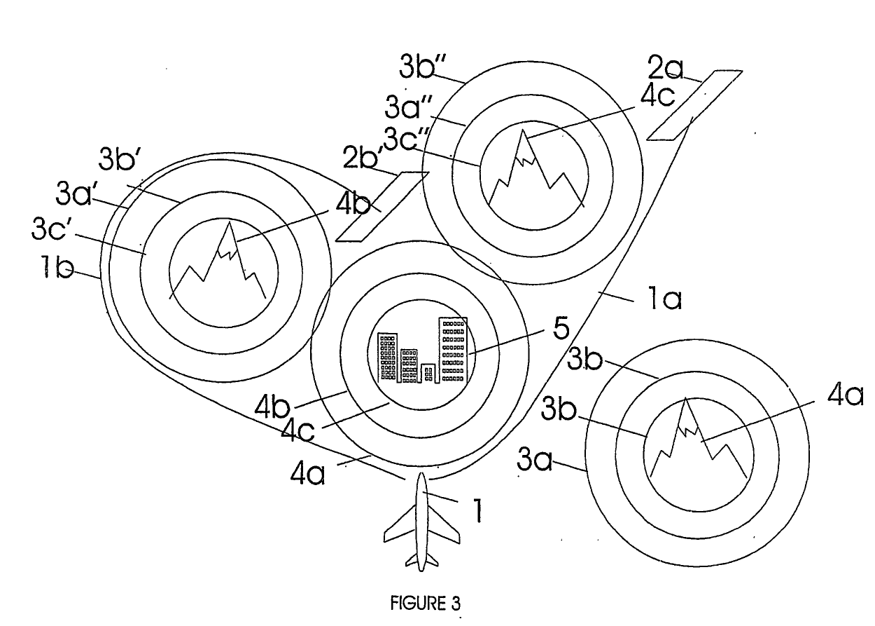

Referring now to the drawings: FIG. 1 shows an aircraft 1 headed for a city 5. If it is commandeered the pilot or any monitoring entity can initiate a signal and take over the aircraft and fly it to one of the airports identified as 2a and 2b. Mountains 4a, 4b and 4c present obstacles which the aircraft must avoid. Obstacles can be identified by a set off distance as represented in FIG. 2 by circles 3a, 3b, and 3c for mountain 4a 3a′, 3b′ and 3c′ as noted for mountain 4b and 3a″, 3b″ and 3c″ for mountain 4c′. These stand off distances may be selected for the individual aircraft size or other criteria and represent the maximum distance which can be tolerated for safety reasons. When the aircraft receives a command, it computes a route which takes it to either airport 2a or 2b and remains outside of the standoff distance. In the case shown in FIG. 3 it appears that the flight to airport 2a is the shortest.

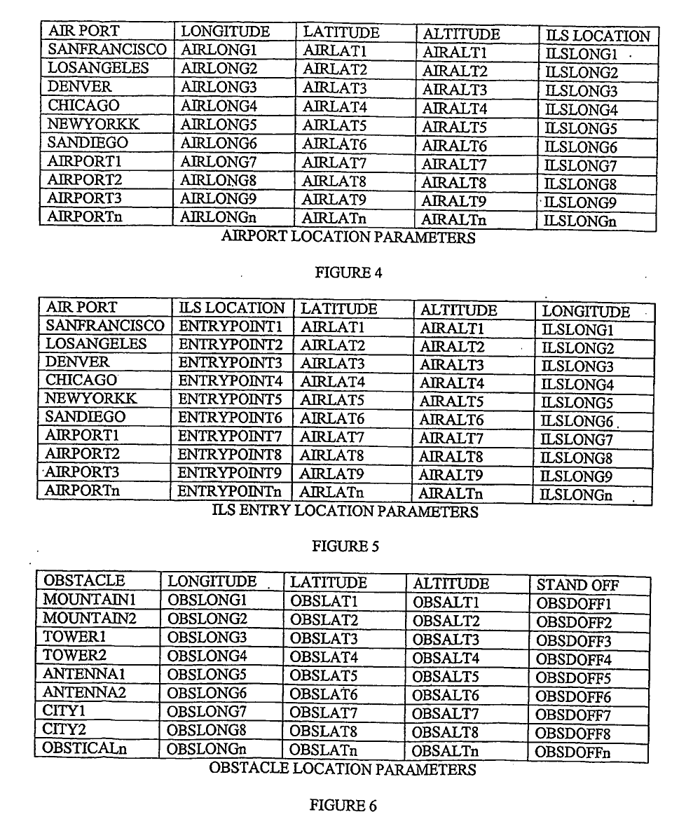

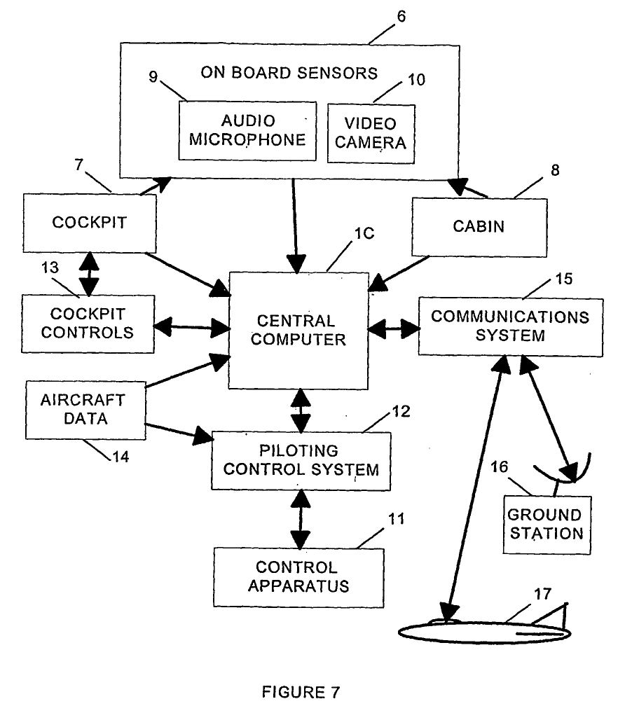

The tables set forth in FIGS. 4-6 represent location information for airports, including Latitude, Longitude, Altitude and ILS location for automatic landing. These can be loaded into the database tables while the aircraft is at the gate, or over wireless communication stations.

FIG. 4 shows a representative control system for an aircraft. A central computer 5 may be in the electronics bay of the aircraft, however, it may also be located in areas accessible only when the aircraft is on the ground. This prevents tampering with the system while in flight. There are a number of on board sensors 6 which are distributed about the cockpit 7 and cabin 8. These are at least an audio microphone 9 or video camera 10 and preferably both. Numerous ones of each of these may be used simultaneously.

The cockpit controls 13 interfaces with the central computer 1 to access the control apparatus 11 and may include access to an auto pilot or piloting control system routine 12. When the piloting control system is active it fly's the aircraft according to settings entered by the pilot within the control laws of the particular aircraft. When the emergency system is activated the piloting control system uses information set in the central computer 5, which may be either hard wired in the form of ROM or uploaded from the ground. This information uses the tables. Additional sensors provide aircraft data 14 for use by the emergency control system and the piloting system. The central computer interfaces 1 with a communications system 15 which may be broad band or narrow band dependent on the amount of data to be transmitted. This communications system is in two way communication with either a Ground station 16 or an optional chase aircraft 17.

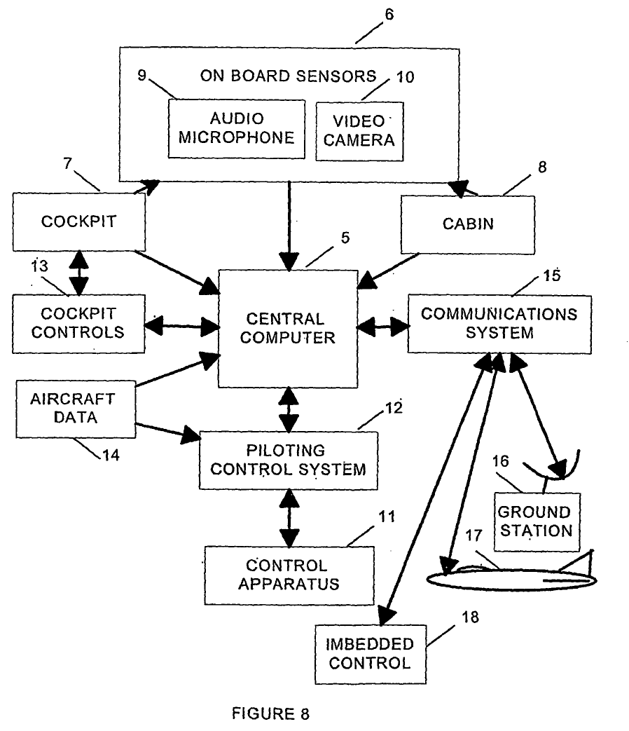

Referring to FIG. 8, an optional imbedded control is included which provides the hard wired code for the various control modules and the table storage. This may also include preprogrammed routes and waypoints.

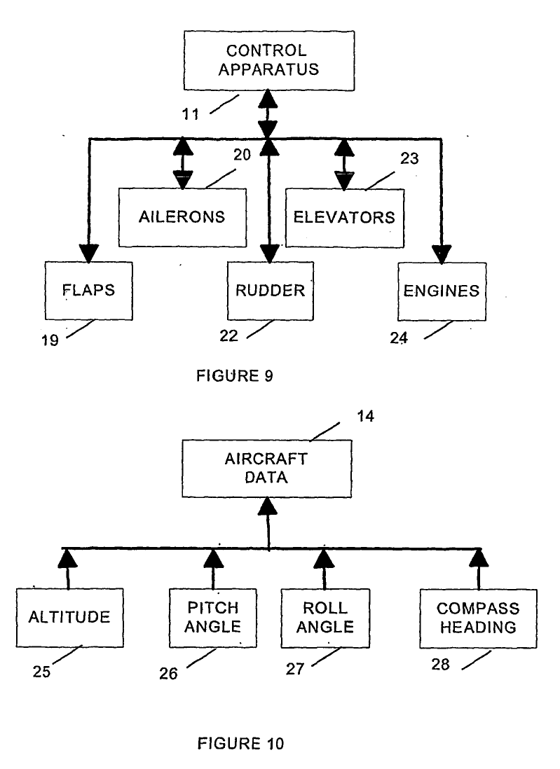

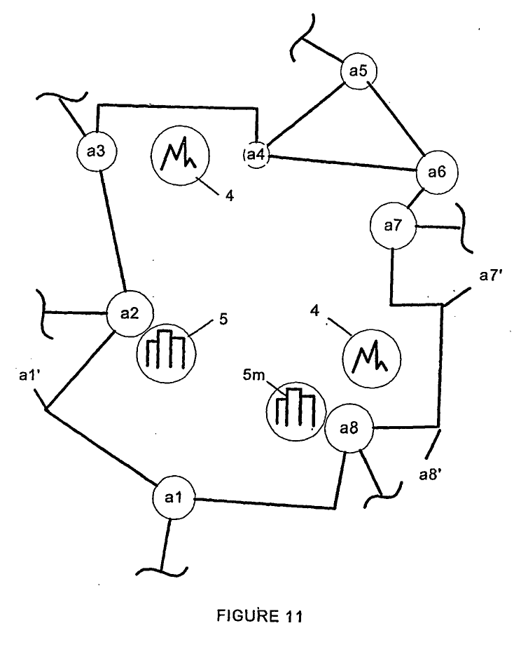

FIGS. 9 and 10 show the control apparatus in two way contact with the various controls. At a minimum these should be the Flap Actuators 19, Aileron actuators 20, Rudder actuators 22, elevator actuators 23, and engine actuators 24. The Control apparatus 11 is in wireless contact with the central computer 5 and may be used to control all of the control surfaces necessary to fly the aircraft or any subset thereof. The aircraft data 14 is derived from at least Altitude 25, pitch angle 26 roll angle 27 and compass heading 28 information which is sufficient to determine the attitude and direction of the aircraft.

An alternative embodiment shows a route construction of emergency paths which avoid obstacles and fly over relatively uninhabited areas. The example shown in FIG. 11, illustrates such a system. The various emergency paths are shown as the black lines data for establishing at least three emergency path approaches to airports. The airports in this diagram are indicated by the letters a1 through a8. Although this diagram could go on indefinitely over the entire United States if not the World. These paths may be pre-programmed into the central computer 5 to avoid obstacles, cities and inhabited areas or downloaded before flight. FIG. 11 also shows cities 5 and mountains 4, encircled by their stand off distances. In this particular case route 29a is not a straight line which is an indication that it was determined that the straight line area passed over heavily inhabited areas or other sensitive region. The emergency route 29 areas which end with a cut off symbol would go to yet another airport but the drawing is limited due to size considerations.

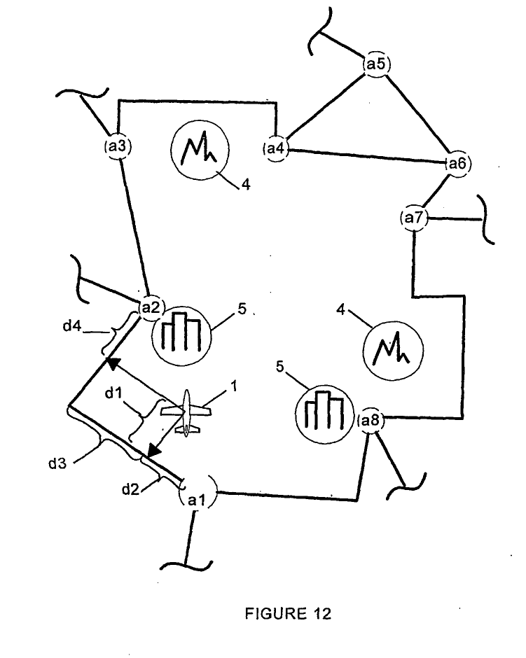

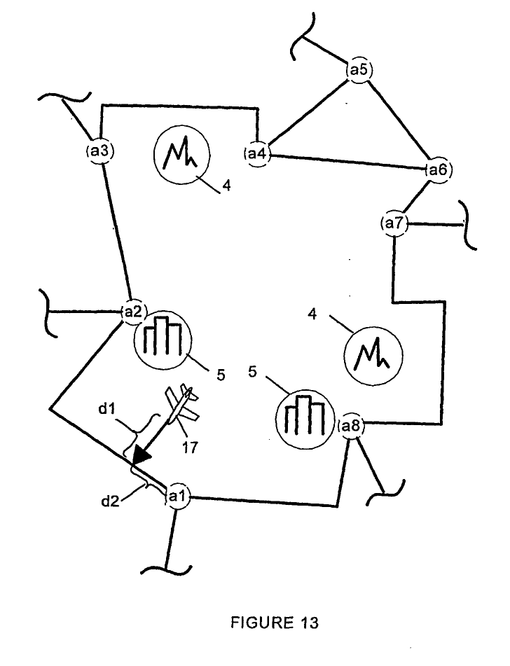

In FIG. 12, an aircraft 1 has an emergency which has been determined a take over or other situation by which the on board crew is unable to maintain the scheduled route. Accordingly the central computer 5 uses a table of predetermined emergency routes to locate the closest emergency paths to the aircraft 1. In the particular example, route 29a, shows the path is the same path between two airports. Since the Aircraft needs to fly to the closest airport on the emergency route 29 between airports a1 and a2, the central computer 5 calculates the distances to the path 29 from the aircraft to respective distances between the airports. It does this by calculating the aircraft's location using the aircraft data and uses the emergency route location information stored in the central computer 5 in form of table data. Thus, the computer can calculate the most direct route to the airport. For that part of the emergency route closes to airport a1, the central computer computes the shortest distances d1 to the contact point on the emergency path 29 to the airport a1. The central computer does the same in calculating the distance d3 for the contact point on the emergency route to airport a2. The central computer then calculates the distance d2 from the contact point to the airport a1 and sums d1 and d2 for the distance to be traveled. Similarly d4 is also calculated and summed with d3 for the distance to be traveled to a1. As can be seen d1 plus d2 is the shortest distance to be traveled and as shown in FIG. 13, the computer system 5 will command the piloting control system to travel to the contact point for d1 and then turn and follow the emergency route along d2. Once the aircraft reaches the airport it will enter the ILS system and land at the airport. It should be noted in this example it may be best to take the longest route to airport a2 because it has the shortest flight over heavily inhabited areas. Accordingly, additional information may call for a different manner of calculating d1 or d3 or both. Accordingly, the specific calculations suggested herein are merely exemplary in nature and may require modification or simplification.

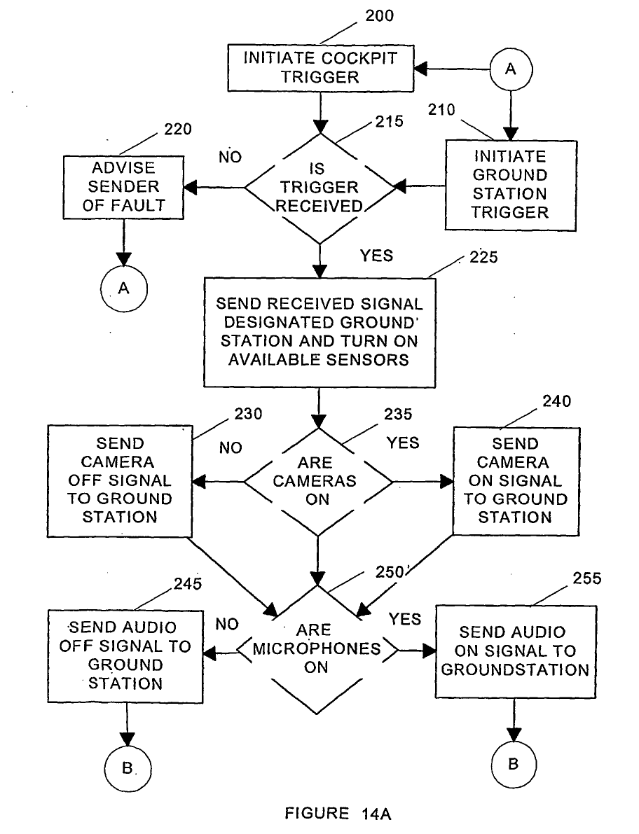

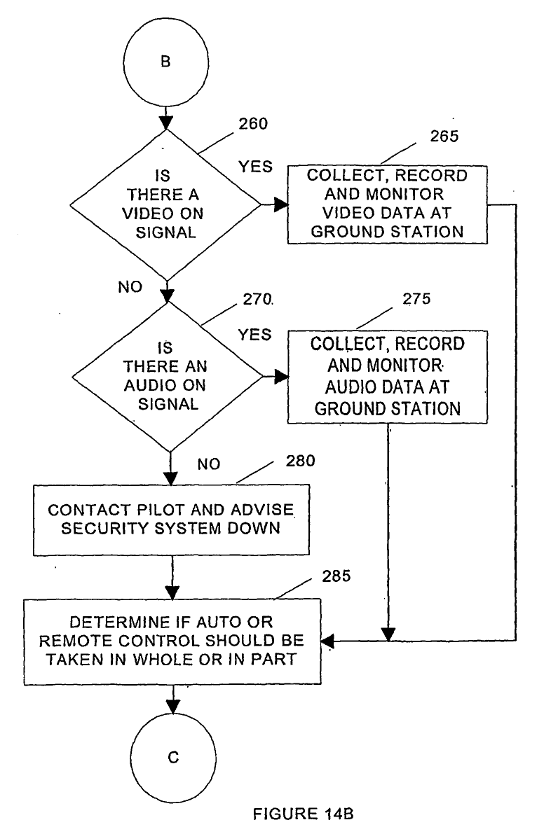

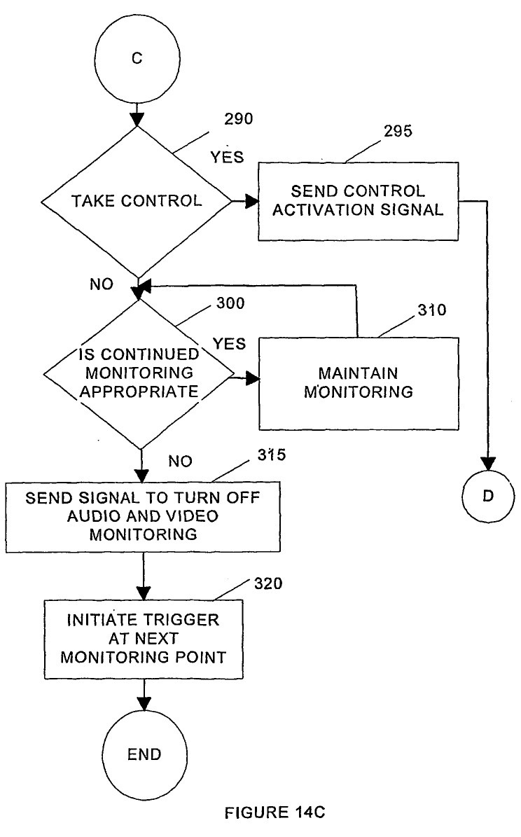

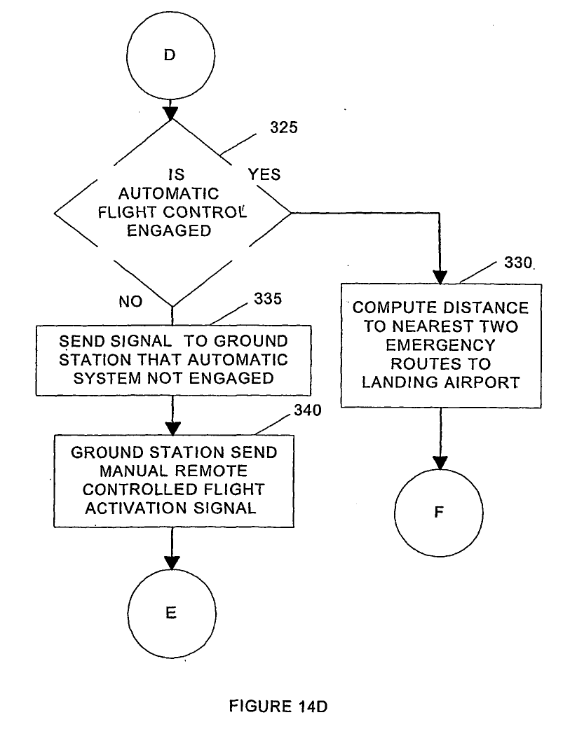

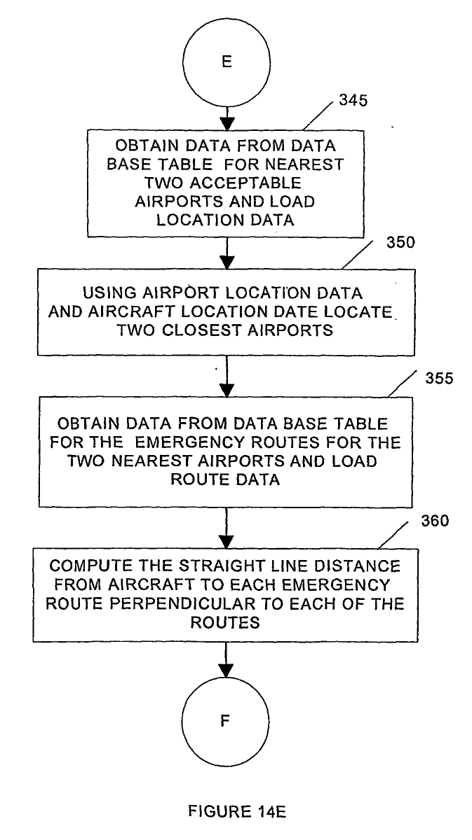

The method for implementing this system is set forth in FIGS. 14A through 14F. In FIG. 14A the first step is to receive a trigger signal from either the cockpit 7 (or elsewhere on the aircraft) step 200, or receive a trigger signal from a ground station 16 or another aircraft 17, step 210 as described above. Receipt of the trigger signal, step 215, must be acknowledged step 225 or a fault is sent, step 220. On acknowledgement, a send received signal is sent to the ground station and the available sensors 6 are turned on, step 225. If the cameras turn on, step 235, “a camera on” signal is sent to ground station 16 or aircraft 17, step 240, if not then “a camera off” signal is sent, step 230. If the microphones turn on, step 250, “a microphone on” signal is sent to ground station 16 or aircraft 17, step 255, if not then “a microphone” off signal is sent, step 245. If the video or the audio signals are on, step 260 of FIG. 14B, then the ground station collects video 265 or audio, step 270 or both data and records the same, step 265, and 275. A determination is made based on that data whether or not to initiate full or partial remote control, step 285. That is, some of the control apparatus may be isolated and others permitted access from the cockpit. If there is no signal the pilot is contacted and advised that the security system is down, step 280. A code could be devised to alert the ground that the security devices were disabled by hijackers.

If a decision is made to take control, step 290 then the ground station or other monitoring station sends a control activation signal step 295, the electronic fly-by-wire interface to the cockpit is severed and the central computer takes over, step 325. The central computer 1C computes location of nearest airport, step 330, examines data base and retrieves Airport and Load data, step 345 and identifies the two closes acceptable airports, step 350. The database is interrogated for the preset emergency routes for the two nearest airports and loads route data, step 355. The central computer 1C then calculates the straight line distance from aircraft to each emergency route perpendicular to each of the routes, step 360, however as noted herein the perpendicular calculation is the most expedient method and there may be other factors which would indicate a different calculation. The central computer 1C then computes the distance from the calculated contact point for each route to the nearest airport, step 375. The computer then fly's the appropriate emergency route to an airport along the shortest route obtained of the routes to each airport. It then enters the automatic landing system and lands the aircraft at the designated airport and the system stops. The cockpit controls remain isolated until the authorities take control of the aircraft or otherwise resolve the emergency. If the decision is to not take control, step 300, then continued monitoring, step 310 may take place or shut down the monitoring, step 315 and revisit at the monitoring point in time or on schedule when another trigger signal may be issued, step 320.

If however, There is no monitoring capability, this will be determined very early, the pilot contacted and advised that the security system is down, step 280 and then a decision could be made to determine if complete auto mode should bed entered, step 285 and the vehicle irretrievably sent to an airport landing site. Alternatively, partial remote control could still be taken in whole or in part, step 285, by either the ground station or a chase plane 17.

All communications are of course encrypted or sent via spread spectrum techniques to maintain security. However, in the event of breach of any stand off zone the hardwired code will execute and the system will irretrievably land at the nearest acceptable airport.

The cameras may be continuously operating or turned on only in the event of a distress signal operated from the cockpit to alert ground personnel to monitor cockpit and cabin activities in real time. While the described system is to be used for surfing the Internet while aboard the aircraft or vehicle, in an emergency, the communication system uses it full bandwidth to transmit video data, since there would be little interest in the case of a hijack situation in using the communication system for surfing the Internet, or other entertainment. Thus, the full bandwidth of the communication system is dedicated to the data gathering system, which permits transmission of the high bit rate requirements of video. This would provide authorities with critical real time decision information to determine what and where to evacuate, tactical decision information and general information as to what is taking place on the aircraft. It is understood that various different communication systems could be used for this purpose and video data gathering would need to be sampled to fit the needs of the communication system.

In present invention, the communication system is interfaced with the aircraft fly by wire system and when engaged provide ground control of the aircraft in flight. That is, once a pilot indicates a distress situation or when any emergency is determined by ground control, which cannot be addressed by the pilot, the communication system is used to send control information to the on board flight computer to cause the fly by wire system to control the flight of the aircraft.

Aircraft position and other information would similarly be transmitted to ground control. An interface to these systems is within the skill of the art.

The autopilot would be set by ground control commands for a destination, and reprogrammed as necessary during the flight. When a destination is reached the automatic landing system is activated at the appropriate approach point and takes over landing of the aircraft.

There is a risk that a hijacker could break into or hack into the communication system and interfere with the ground control at the time the pilot tuns over the aircraft to ground control. This could permit the hijacker to still control the aircraft if they are able to successfully enter the control system.

Therefore, a default, aircraft return system, which would return the aircraft to an airport is included as an alternative embodiment. The control system downloads location information for all of the airports within an area reachable by the fuel load on the aircraft when at the loading gate by either wire or wireless information transfer. Alternatively, the airport location may be preloaded for aircraft, which regularly fly particular routes. This data is stored into an airport database, which is used for comparison against a GPS location reference. The airport database includes at least airport locations, ILS or other landing system information and runway information.

In the event of an emergency a cockpit control operable by the pilot or an onboard marshal, or a ground control operable by ground personnel is used to activate a computer routine which computes the aircraft location at the time the control is set and then determines the route to the nearest airport in the data base capable of accepting aircraft as designated in the control program for the airport.

Emergency transponders aboard the aircraft are activated to indicate to ground control that the aircraft has an emergency in which the pilot is usable to control the operation of the aircraft.

Once activated the cockpit will remain isolated from fly by wire commands so that the aircraft cannot be rerouted or the control reset nor can the aircraft be forced into the ground or any structures. It will land at the nearest airport designated by the control program.

The wireless surveillance system will remain active, as it does not include control information and would continue to provide video data to the ground.

Ground personnel will need to clear the designated airport runways and ensure that the ground beacons are on for the approaching aircraft landing systems. Once the ground, full controls will be restored but high speed will not be permitted. Throttle will be adjustable based on time differential information for GPS location data to limit speed to taxi speed only. The wireless system may then be used to direct the aircraft to a remote location at the airport. The aircraft will then proceed to a designated location in the airport for processing by emergency or security personnel. Control will remain with the remote monitoring station until the event is completed.

Emergency response personnel and the authorities may then determine how to end the hijacking.

The specific embodiments as noted above are by way of example and are not intended that the scope of this invention be limited to the specific embodiments and shall be as broad but shall be as broad as the claims will allow. Variations and modifications of the above described invention will be apparent to those skilled in the art of aircraft flight, communications and control and such are to be included within the scope of this invention.

Having thus described the invention what is claimed is:

1. A control system for a movable vehicle comprising:
a. a control apparatus for controlling the motion of the movable vehicle;
b. at least one location in communication with said movable vehicle while the vehicle is in motion to monitor on board activities.
c. a communication system coupled between the station and the movable vehicle for sending and receiving information related to said board activities; and
d. a control signal which permits the at least one location to selectively operate said control apparatus for controlling the motion of the movable vehicle.

2. A control system for a movable vehicle as described in claim 1 further comprising:
a. An automatic piloting system on board said mobile platform

3. A control system for a movable vehicle as described in claim 2 wherein said mobile platform is an aircraft and said control system further comprises:
a. An automatic landing system on board said moveable vehicle capable of communicating with to said automatic piloting system

4. A control system for a movable vehicle comprising:
a. a control apparatus for controlling the motion and direction of the movable vehicle;
b. at least one location in communication with said movable vehicle while the vehicle is in motion to monitor on board activities.
c. a communication system coupled between the station and the movable vehicle for sending and receiving information related to said board activities; and
d. a control signal, which permits the station to operate said control apparatus for controlling the motion and direction of the movable vehicle.

5. A control system for a movable vehicle as described in claim 4 further comprising:
a. An automatic motion control system on board said moveable vehicle.

6. A control system for a movable vehicle as described in claim 5 wherein said automatic motion control system farther comprises:
a. An automatic parking system.

7. A control system for a movable vehicle comprising:
a. a control apparatus for controlling the motion of the movable vehicle;
b. at least one station in communication with said movable vehicle while the vehicle is in motion to monitor on board activities.
c. a communication system coupled between the station and the movable vehicle for sending and receiving information related to said board activities; and
d. a control signal, which permits the station to operate said control apparatus for controlling the motion of the movable vehicle.
e. An automatic pilot system on board said mobile platform.

8. A control system for a movable vehicle as described in claim 2 wherein said mobile platform is an aircraft and said control system further comprises:
a. An automatic landing system on board said moveable vehicle.

9. A control system for a movable vehicle comprising:
a. a control apparatus for controlling the motion and direction of the movable vehicle;
b. at least one station in communication with said movable vehicle while the vehicle is in motion to monitor on board activities.
c. a communication system coupled between the station and the movable vehicle for sending and receiving information related to said board activities; and
d. a control signal, which permits the station to operate said control apparatus for controlling the motion and direction of the movable vehicle.

10. A control system for a movable vehicle as described in claim 4 further comprising:
a. An automatic motion control system on board said moveable vehicle.

11. A control system for a movable vehicle as described in claim 5 wherein said control apparatus further comprises:
An automatic parking system on board said moveable vehicle.
